(19) United States
(12) Patent Application Publication
(10) Pub. No.: US 2025/0240205 A1
(43) Pub. Date: Jul. 24, 2025

(54) SYSTEM FOR ALLOCATION OF NETWORK RESOURCES FOR EXECUTING DEEP LEARNING RECOMMENDATION MODEL (DLRM) TASKS

(71) Applicant: Mellanox Technologies, Ltd., Yokneam (IL)

(72) Inventors: Ioannis (Giannis) PATRONAS, Piraeus (GR); Nikolaos TERZENIDIS, Kilkis (GR); Eitan ZAHAVI, Zichron Yaakov (IL); Paraskevas BAKOPOULOS, Ilion (GR); Zsolt-Alon WERTHEIMER, Kiryat Ata (IL); Dimitrios SYRIVELIS, Volos (GR); Prethvi Ramesh KASHINKUNTI, Chicago, IL (US); Louis Bennie CAPPS, JR., Georgetown, TX (US); Julie Irene Marcelle BERNAUER, Palo Alto, CA (US); Elad MENTOVICH, Tel Aviv (IL)

(73) Assignee: Mellanox Technologies, Ltd., Yokneam (IL)

(21) Appl. No.: 18/415,878

(22) Filed: Jan. 18, 2024

(30) Foreign Application Priority Data
Dec. 20, 2023 (GR) 20230101060

(51) Int. Cl. H04L 41/0806; H04L 41/0816; H04L 41/12

(52) U.S. Cl. CPC H04L 41/0806; H04L 41/0816; H04L 41/12

(57) ABSTRACT

Systems, computer program products, and methods are described herein for allocation of network resources for executing deep learning recommendation model (DLRM) tasks. An example system receives a task and an input specifying information associated with execution of the task, wherein the input comprises a plurality of hosts, determines a plurality of leaf switches based on the plurality of hosts, operatively couples each leaf switch to a subset of the plurality of hosts to configure a network structure; and triggers the execution of the task using the network structure.

### CROSS-REFERENCE TO RELATED APPLICATIONS

This application claims priority to Greek patent application No. 20230101060, filed Dec. 20, 2023, the entire contents of which application are hereby incorporated herein by reference.

### TECHNOLOGICAL FIELD

Example embodiments of the present invention relate to network communications and, more particularly, to efficient resource utilization and adaptability in distributed computing environments.

### BACKGROUND

In the field of distributed computing, the demand for high-performance data exchange has risen significantly, especially in applications such as deep learning. Traditional network architectures are often constructed around static topologies, which may be suboptimal for handling the intricacies of modern computational demands. In the field of machine learning, there is a growing need for a solution capable of facilitating efficient data exchange for the execution of computationally intensive tasks.

Applicant has identified a number of deficiencies and problems associated with conventional network systems and associated communications. Many of these identified problems have been solved by developing solutions that are included in embodiments of the present disclosure, many examples of which are described in detail herein.

### BRIEF SUMMARY

Systems, methods, and computer program products are therefore provided for allocation of network resources for executing computationally intensive machine learning tasks in a dynamic, structured hierarchical network.

In one aspect, a method for allocation of network resources for executing a deep learning task is presented. The method comprising: receiving a task and an input specifying information associated with execution of the task, wherein the input comprises a plurality of hosts; determining a plurality of leaf switches based on the plurality of hosts; operatively coupling each leaf switch to a subset of the plurality of hosts to configure a network structure; and triggering the execution of the task using the network structure.

In some embodiments, the input comprises a communication pattern, and wherein the method further comprises: determining, based on the communication pattern, a number of optical circuit connections required to operatively interconnect each pair of leaf switches from the plurality of leaf switches; and operatively interconnecting, using the optical circuit connections, the plurality of leaf switches.

In some embodiments, operatively interconnecting, using the optical circuit connections, the plurality of leaf switches forms a complete graph.

In some embodiments, the optical circuit connections are bidirectional links.

In some embodiments, the communication pattern comprises at least one of an all-to-all, a reduction operation, or scatter-gather.

In some embodiments, the number of optical circuit connections determined to satisfy a bandwidth requirement associated with the network structure.

In some embodiments, each pair of leaf switches comprises a first leaf switch and a second leaf switch, wherein the number of optical circuit connections for each pair of leaf switches is determined based on at least the subset of the plurality of hosts operatively coupled to the first leaf switch (hi), the subset of the plurality of hosts operatively coupled to the second leaf switch (hj), and the plurality of hosts (N).

In some embodiments, the number of optical circuit connections is determined using an integer approximation function to round the number of optical circuit connections up to a whole number, wherein the integer approximation function comprises at least a ceiling function or a rounding function.

In some embodiments, the number of optical circuit connections for each pair of leaf switches is determined based on:

$$q * ⌈ \frac{{h}_{i} * {h}_{j}}{N} ⌉$$

In some embodiments, if the bandwidth requirement is a full bisection bandwidth requirement, q is set to 1, and wherein if the bandwidth requirement is less than the full bisection bandwidth requirement, q is set to a value less than 1.

In some embodiments, each leaf switch comprises a plurality of uplink ports configured to operatively couple said leaf switch to a plurality of optical switches and a plurality of downlink ports configured to operatively couple said leaf switch to the plurality of hosts.

In some embodiments, the task is a deep learning recommendation model (DLRM) task.

In another aspect, a system for allocation of network resources for executing a deep learning task is presented. The system comprising: a processing device; and a non-transitory storage device containing instructions that, when executed by the processing device, cause the processing device to: receive a task and an input specifying information associated with execution of the task, wherein the input comprises a plurality of hosts; determine a plurality of leaf switches based on the plurality of hosts; operatively couple each leaf switch to a subset of the plurality of hosts to configure a network structure; and trigger the execution of the task using the network structure.

In yet another aspect, a computer program product for allocation of network resources for executing a deep learning task is presented. The computer program product comprising a non-transitory computer-readable medium comprising code configured to cause an apparatus to: receive a task and an input specifying information associated with execution of the task, wherein the input comprises a plurality of hosts; determine a plurality of leaf switches based on the plurality of hosts; operatively couple each leaf switch to a subset of the plurality of hosts to configure a network structure; and trigger the execution of the task using the network structure.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIG. 1 illustrates an example network environment for allocation of network resources for executing deep learning recommendation model (DLRM) tasks, in accordance with an embodiment of the present disclosure;

FIG. 2 illustrates an example system circuitry for allocation of network resources for executing DLRM tasks, in accordance with an embodiment of the present disclosure; and

FIG. 3 illustrates a schematic representation of a complete graph structure comprising a plurality of hosts and a plurality of leaf switches, in accordance with an embodiment of the invention;

FIG. 4 illustrates an example method for allocation of network resources for executing DLRM tasks, in accordance with an embodiment of the present disclosure.

### DETAILED DESCRIPTION

### Overview

In the realm of distributed computing, the increasing demand for high-performance data exchange (e.g., in deep learning applications) presents significant challenges. Traditional network architectures, anchored around static topologies with spine and leaf switches, often grapple with network congestion and latency. These challenges stem primarily from the simultaneous communications occurring between multiple servers. Furthermore, these static designs lack the adaptability to efficiently accommodate the diverse requirements of different tasks or applications. This rigidity can lead to two major pitfalls: overprovisioning, which results in resource wastage, and underprovisioning, which causes performance bottlenecks. To address these concerns, a dynamic, structured hierarchical network is introduced.

At the foundation of this dynamic, structured hierarchical network are the hosts. A host may be a single computational unit, equipped with the capability to independently execute parts of the task. Alternatively, a host may be a cluster of computational units interconnected via an internal network, functioning collectively as a single entity. In this clustered configuration, the host, as the single entity, may independently execute parts of the task, leveraging the interconnected nature of its multiple computational units. Each host is equipped with ports. These ports provide the primary interface for the servers to connect with the network. Every port from a host is directly coupled to a port on a switch (e.g., leaf switch), serving as the first layer of network distribution. These switches may further be coupled to other switches (e.g., spine switches), serving as the second layer of network distribution. Subsequently, these switches interface with optical switches which, in turn, facilitate data communication among various hosts through the coupled switches. The coupling between the switches and the optical switches can be established in a one-to-one manner, or the coupling can be bundled together for increased capacity and flexibility. By leveraging optical switches, the architecture benefits from rapid data transfer rates, reduced latency, and the ability to dynamically reconfigure the network as needed. According to embodiments of the invention described herein, this multi-tiered approach ensures efficient resource utilization, scalability, and a high degree of adaptability to various computational demands.

Embodiments of the invention relate to dynamic allocation of network resources in the structured hierarchical network for a deep learning task, such as a deep learning recommendation model (DLRM) task. DLRM is a type of recommendation system that is widely used in various applications such as e-commerce, video streaming, and social media to provide users with personalized content of product suggestions. DLRMs' uses both categorical data, such as user IDs and item IDs, and continuous data, such as ratings or time stamps to provide appropriate recommendations. DLRM models are typically trained using large datasets to ensure accurate recommendations. Consequently, the training phase of a DLRM is computationally intensive as using large datasets to train the model demands substantial memory and processing power. This is primarily due to the intricate architecture of the model, including multiple embedding layers and multilayer perceptrons. Furthermore, the optimization of loss functions requires iterative processes, wherein each iteration updates weights and biases based on gradients. Such continual updating processes mandates significant computational capacity.

Beyond computational power, the efficacy of DLRM training is closely linked to the efficient allocation and utilization of network resources. The transmission of large datasets over a network, coupled with the need for parallel processing in distributed training scenarios, places a premium on bandwidth and low-latency connections. Any bottleneck in data flow can hinder the model's convergence speed and overall training efficiency. Given the size and complexity of the model, particularly when training on large datasets, it is imperative to ensure that adequate computational and network resources are dedicated to the task. Inadequate resources can result in prolonged training times, suboptimal model performance, or even training failures.

Efficient allocation can be achieved through techniques such as dynamic resource scaling, wherein resources are scaled up or down based on the model's demands. With varying computational demands, systems can often experience fluctuations in resource utilization. Dynamic resource scaling, according to embodiments of the invention, ensures optimal resource utilization, enhancing both efficiency and cost-effectiveness. In addition to the allocation of computational resources, ensuring optimality necessitates efficient distribution of tasks across multiple hosts. Part of this distribution requires knowledge of the specific communication pattern to be employed. A communication pattern may refer to a predefined set of rules or protocols that dictate how data is exchanged between computational entities, such as hosts or nodes, within a network or system. In this way, a communication pattern provides a structured approach to managing data flow and ensures that entities interact and share information in a consistent and efficient manner. Examples of a communication pattern may include all-to-all, reduction operations (e.g., all-reduce), scatter-gather, and/or the like. In an all-to-all communication pattern, every host communicates with every other host, ensuring that every host has access to the data it needs from every other host. In an all-reduce communication pattern, data held on each host is combined using an operation (e.g., summation) and then the result is broadcast back to all the hosts, allowing the hosts to work on a unified dataset.

For a deep learning task, embodiments of the invention assess the designated number of hosts and the specified communication pattern (e.g., all-to-all, reduction operations, scatter-gather, and/or other communication patterns). Based on this assessment, the system calculates the necessary number of leaf switches and the corresponding optical circuit connections between these leaf switches, ensuring compliance with the full-bisection bandwidth requirement. In this way, embodiments of the invention may dynamically configure the network structure, adapting in real-time to the given parameters and information to optimize data flow and connectivity.

Accordingly, the system may receive a task and an input specifying information associated with execution of the task, such as a number of allocated hosts and a communication pattern. In response, the system may determine the number of required leaf switches, where each leaf switch is operatively coupled to a varying number of hosts. While the number of leaf switches is determined based on the number of allocated hosts, the connectivity among the leaf switches are based on the specific communication pattern. For instance, if the number of allocated hosts, N, is 128, and each leaf switch has 32 ports for uplink (connecting to an optical switch) and 32 ports for downlink (connecting to a host), then each leaf switch is capable of being operatively coupled to 32 hosts. Therefore, for 128 hosts, a minimum of 4 leaf switches are required. Each leaf switch may be operatively coupled to a varying number of hosts (h1, h2, . . . , hp), where h1 refers to number of hosts under leaf 1, h2 refers to number of hosts under leaf 2, and so on, where p=4 and Eᵢ₌₁^{p}hᵢ=128 in this example.

In example embodiments where the required communication pattern is all-to-all, the system may establish a full graph topology to form a complete graph between the leaf switches such that each host is configured to send a fraction (1/N) of its link's bandwidth to every other host in the network. Further, any host on a specific leaf switch “p” sends a share of its bandwidth, calculated as (N-hp)/N, to hosts on all other leaf switches. Upon establishing the full graph topology, the system may determine the total number of bidirectional optical circuit connections between any two leaf switches as a product of the total number of hosts under each leaf switch divided by the total number of available hosts [(h1*h2)/N], where the ceiling function (or any equivalent integer approximation function) ensures that the number of links is rounded up to the nearest whole number and there is no impact in performance. As in the previous example, if there is an equal number of hosts under each leaf switch, the required number of optical switch uplinks between each leaf switch may be determined as [(32*32)/128]=8. Therefore, the total number of optical switch uplinks required for each leaf switch is 8+8+8=24 in this example. In this way, embodiments of the invention may efficiently and dynamically allocate network resources by balancing the specific bandwidth needs of each host and accounting for the distribution of hosts across multiple leaf switches.

While the present disclosure has been predominantly described with reference to certain embodiments tailored to deep learning tasks, such as DLRM, it should be understood that the scope of the invention is not confined to these specific embodiments. The invention is intended to cover any models that possess a similar structure or function to DLRMs, encompassing various modifications, adaptations, and equivalent arrangements within its breadth. Accordingly, the description provided herein is meant to be exemplary rather than limiting, with the intention that the claims of the invention are applicable to other models and tasks that demonstrate analogous network resource allocation and management requirements as those detailed for DLRMs.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “interconnected” may imply that each component is directly or indirectly linked to every other component or switch in the network, allowing for seamless data transfer and communication between all the components.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

It should be understood that the word “exemplary” is used herein to mean “serving as an example, instance, or illustration.” Any implementation described herein as “exemplary” is not necessarily to be construed as advantageous over other implementations.

Furthermore, as would be evident to one of ordinary skill in the art in light of the present disclosure, the terms “substantially” and “approximately” indicate that the referenced element or associated description is accurate to within applicable engineering tolerances.

### Example Network Environment

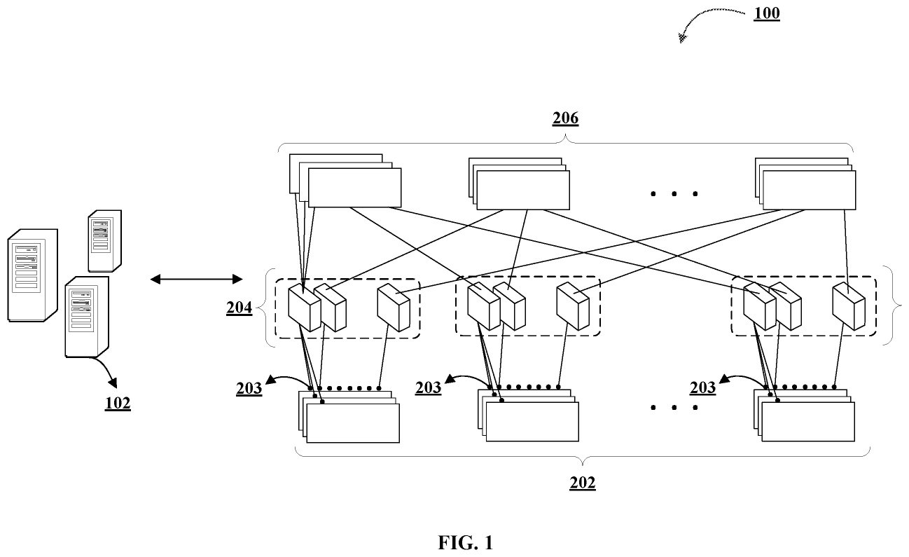

FIG. 1 illustrates an example network environment 100 for allocation of network resources for executing a deep learning task, in accordance with an embodiment of the present disclosure. As shown in FIG. 1, the network environment 100 may include a system 102, a plurality of hosts 202, a plurality of leaf switches 204, and a plurality of optical switches 206.

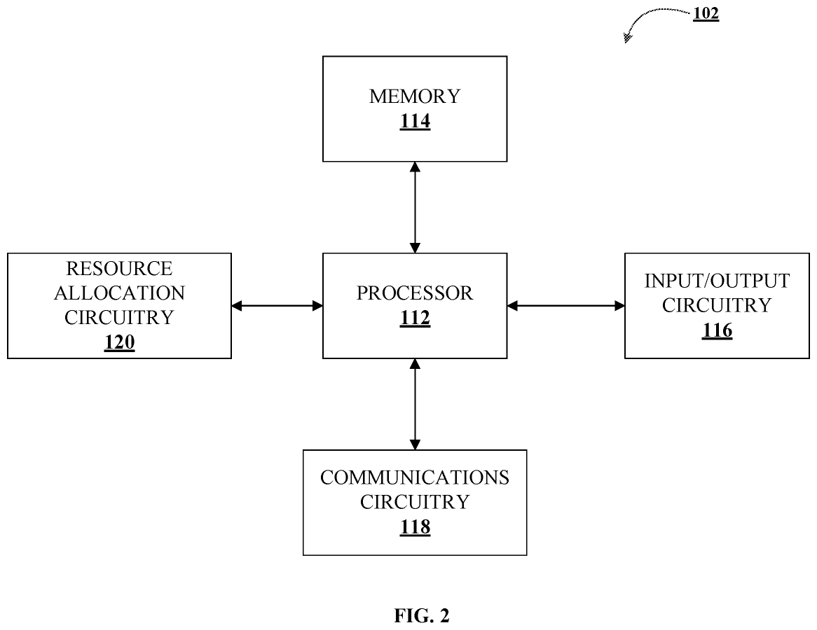

As shown in FIG. 1, the network environment 100 may include a system 102, described in further detail in FIG. 2. The system 102 may communicate with one or more components (e.g., the plurality of hosts 202) associated with the network environment 100 to execute embodiments of the invention described herein. The system 102 may be implemented in a number of different forms. For example, the system 102 may be implemented as a standard server, or multiple times in a group of such servers. Additionally, the system 102 may also be implemented as part of a rack server system or a personal computer such as a laptop computer. Alternatively, components from the system 102 may be combined with one or more other same or similar systems, and an entire system 102 may be made up of multiple computing devices communicating with each other. The system 102 may represent various forms of servers, such as web servers, database servers, file servers, or the like, various forms of digital computing devices, such as laptops, desktops, workstations, or the like, or any other auxiliary network devices, Internet-of-things devices, electronic kiosk devices, mainframes, or the like, or any combination of the aforementioned.

As shown in FIG. 1, the network environment 100 may include a plurality of hosts 202. As described herein, a host may be a single computational unit, or a cluster of computational units interconnected via an internal network, functioning collectively as a single entity, configured to perform computational tasks (e.g., DLRM task) and facilitate data exchange within the network environment. Each host may be equipped with ports 203 that may serve as a primary means of connection to the network. Each host may be operatively coupled to a leaf switch 204. In example embodiments, the coupling is achieved via Ethernet cables, employing protocols such as Transport Control Protocol (TCP)/Internet Protocol (IP) for communication.

As shown in FIG. 1, the network environment 100 may include a plurality of leaf switches 204. According to embodiments of the invention, leaf switches serve as the primary layer of network distribution in the described network structure, acting as an intermediary between the hosts 202 and the subsequent layers of the network. In embodiments where the hosts are in an interconnected clustered configuration, the leaf switches may act as intermediary between the computational units across the hosts 202 such that each computation unit in a particular host may be connected to a corresponding computational unit in another host. Each leaf switch 204 may include a plurality of uplink ports. These uplink ports may be configured to operatively couple the leaf switches 204 to the plurality of optical switches 206. Additionally, each leaf switch 204 may include a plurality of downlink ports. These downlink ports may be configured to operatively couple the leaf switches 204 to the plurality of hosts 202. For instance, if the number of hosts 202, N, is 128, and each leaf switch 204 has 32 ports for uplink (connecting to an optical switch) and 32 ports for downlink (connecting to a host), then each leaf switch 204 is capable of being operatively coupled to 32 hosts 202. Therefore, for 128 hosts 202, a minimum of 4 leaf switches 204 may be required. Each leaf switch 204 may be operatively coupled to a varying number of hosts 202 (h1, h2, . . . , hp), where h1 refers to number of hosts under leaf 1, h2 refers to number of hosts under leaf 2, and so on, where p=4. The leaf switches 204 may be interconnected via the optical switches 206.

As shown in FIG. 1, the network environment 100 may include a plurality of optical switches 206. Optical switches may be high speed switches that use light signals for switching and routing data. In specific embodiments, the optical switches 206 may act as intermediaries, routing the light signals between the leaf switches 204 via optical circuit connections. In example embodiments, the optical switches 206 may employ communication protocols such as Optical Transport Network (OTN) or Dense Wavelength Division Multiplexing (DWDM) to facilitate communication between the leaf switches 204, allowing for high-speed, low-latency communication between each leaf switch pair, effectively extending the network's reach and capability.

In the overall network structure, according to embodiments of the invention, when a host initiates a network communication, the data is first received by its directly connected leaf switch. Should the data be intended for a host connected to a different leaf switch, the originating leaf switch transmits the data to an optical switch, which in turn routes the data to the appropriate port on the leaf switch. Finally, the destination leaf switch forwards the data to the intended host. This structure supports bidirectional communication, enabling seamless data flow between hosts connected to different leaf switches via optical switches.

It is to be understood that the structure of the network environment 100 and its components, connections and relationships, and their functions, are meant to be exemplary only, and are not meant to limit implementations of the embodiments described and/or claimed in this document. In one example, the network environment 100 may include more, fewer, or different components. For instance, the network environment 100 may include multiple layers of electrical switches (instead of just one layer of leaf switches shown in the FIG. 1). In another example, some or all of the portions of the network environment 100 may be combined into a single portion or all of the portions of the network environment 100 may be separated into two or more distinct portions.

### Example System Circuitry

FIG. 2 illustrates a schematic block diagram of example circuitry, some or all of which may be included in the system 102. As shown in FIG. 2, the system 102 may include a processor 112, a memory 114, input/output circuitry 116, communications circuitry 118, and resource allocation circuitry 120.

Although the term “circuitry” as used herein with respect to components 112-120 is described in some cases using functional language, it should be understood that the particular implementations necessarily include the use of particular hardware configured to perform the functions associated with the respective circuitry as described herein. It should also be understood that certain of these components 112-120 may include similar or common hardware. For example, two sets of circuitries may both leverage use of the same processor, network interface, storage medium, or the like to perform their associated functions, such that duplicate hardware is not required for each set of circuitries. It will be understood in this regard that some of the components described in connection with the system 102 may be housed together, while other components are housed separately (e.g., a controller in communication with the system 102). While the term “circuitry” should be understood broadly to include hardware, in some embodiments, the term “circuitry” may also include software for configuring the hardware. For example, in some embodiments, “circuitry” may include processing circuitry, storage media, network interfaces, input/output devices, and the like. In some embodiments, other elements of the system 102 may provide or supplement the functionality of particular circuitry. For example, the processor 112 may provide processing functionality, the memory 114 may provide storage functionality, the communications circuitry 118 may provide network interface functionality, and the like.

In some embodiments, the processor 112 (and/or co-processor or any other processing circuitry assisting or otherwise associated with the processor) may be in communication with the memory 114 via a bus for passing information among components of, for example, the system 102. The memory 114 may be non-transitory and may include, for example, one or more volatile and/or non-volatile memories, or some combination thereof. In other words, for example, the memory 114 may be an electronic storage device (e.g., a non-transitory computer readable storage medium). The memory 114 may be configured to store information, data, content, applications, instructions, or the like, for enabling an apparatus, e.g., the system 102, to carry out various functions in accordance with example embodiments of the present disclosure.

Although illustrated in FIG. 2 as a single memory, the memory 114 may comprise a plurality of memory components. The plurality of memory components may be embodied on a single computing device or distributed across a plurality of computing devices. In various embodiments, the memory 114 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. The memory 114 may be configured to store information, data, applications, instructions, or the like for enabling the system 102 to carry out various functions in accordance with example embodiments discussed herein. For example, in at least some embodiments, the memory 114 may be configured to buffer data for processing by the processor 112. Additionally, or alternatively, in at least some embodiments, the memory 114 may be configured to store program instructions for execution by the processor 112. The memory 114 may store information in the form of static and/or dynamic information. This stored information may be stored and/or used by the system 102 during the course of performing its functionalities.

The processor 112 may be embodied in a number of different ways and may, for example, include one or more processing devices configured to perform independently. Additionally, or alternatively, the processor 112 may include one or more processors configured in tandem via a bus to enable independent execution of instructions, pipelining, and/or multithreading. The processor 112 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 1 as a single processor, in some embodiments, the processor 112 may include a plurality of processors. The plurality of processors may be embodied on a single computing device or may be distributed across a plurality of such devices collectively configured to function as the system 102. The plurality of processors may be in operative communication with each other and may be collectively configured to perform one or more functionalities of the system 102 as described herein.

In an example embodiment, the processor 112 may be configured to execute instructions stored in the memory 114 or otherwise accessible to the processor 112. Alternatively, or additionally, the processor 112 may be configured to execute hard-coded functionality. As such, whether configured by hardware or software methods, or by a combination thereof, the processor 112 may represent an entity (e.g., physically embodied in circuitry) capable of performing operations according to an embodiment of the present disclosure while configured accordingly. Alternatively, as another example, when the processor 112 is embodied as an executor of software instructions, the instructions may specifically configure the processor 112 to perform one or more algorithms and/or operations described herein when the instructions are executed. For example, these instructions, when executed by the processor 112, may cause the system 102 to perform one or more of the functionalities thereof as described herein.

In some embodiments, the system 102 further includes input/output circuitry 116 that may, in turn, be in communication with the processor 112 to provide an audible, visual, mechanical, or other output and/or, in some embodiments, to receive an indication of an input from a user or another source. In that sense, the input/output circuitry 116 may include means for performing analog-to-digital and/or digital-to-analog data conversions. The input/output circuitry 116 may include support, for example, for a display, touchscreen, keyboard, mouse, image capturing device (e.g., a camera), microphone, and/or other input/output mechanisms. The input/output circuitry 116 may include a user interface and may include a web user interface, a mobile application, a kiosk, or the like. The input/output circuitry 116 may be used by a user to provide the request and associated parameters associated with the DLRM task.

The processor 112 and/or user interface circuitry comprising the processor 112 may be configured to control one or more functions of a display or one or more user interface elements through computer-program instructions (e.g., software and/or firmware) stored on a memory accessible to the processor 112 (e.g., the memory 114, and/or the like). In some embodiments, aspects of input/output circuitry 116 may be reduced as compared to embodiments where the system 102 may be implemented as an end-user machine or other type of device designed for complex user interactions. In some embodiments (like other components discussed herein), the input/output circuitry 116 may be eliminated from the system 102. The input/output circuitry 116 may be in communication with memory 114, communications circuitry 118, and/or any other component(s), such as via a bus. Although more than one input/output circuitry and/or other component can be included in the system 102, only one is shown in FIG. 2 to avoid overcomplicating the disclosure (e.g., as with the other components discussed herein).

The communications circuitry 118, in some embodiments, includes any means, such as a device or circuitry embodied in either hardware, software, firmware or a combination of hardware, software, and/or firmware, that is configured to receive and/or transmit data from/to a network and/or any other device, circuitry, or module associated therewith. In this regard, the communications circuitry 118 may include, for example, a network interface for enabling communications with a wired or wireless communication network. For example, in some embodiments, communications circuitry 118 may be configured to receive and/or transmit any data that may be stored by the memory 114 using any protocol that may be used for communications between computing devices. For example, the communications circuitry 118 may include one or more network interface cards, antennae, transmitters, receivers, buses, switches, routers, modems, and supporting hardware and/or software, and/or firmware/software, or any other device suitable for enabling communications via a network. Additionally, or alternatively, in some embodiments, the communications circuitry 118 may include circuitry for interacting with the antenna(s) to cause transmission of signals via the antenna (e) or to handle receipt of signals received via the antenna (e). These signals may be transmitted by the system 102 using any of a number of wireless personal area network (PAN) technologies, such as Bluetooth® v1.0 through v5.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. The communications circuitry 118 may additionally or alternatively be in communication with the memory 114, the input/output circuitry 116, and/or any other component of the system 102, such as via a bus. The communication circuitry 118 of the system 102 may also be configured to receive and transmit information with the various components associated therewith.

The resource allocation circuitry 120, in some embodiments, may be used to facilitate execution of the computationally intensive deep learning task, such as a DLRM task. Additionally, the resource allocation circuitry 120 may also be utilized to facilitate other computationally intensive deep learning application tasks, such as large language model (LLM) tasks, ensuring versatile adaptability to various computational challenges. By taking into account input variables such as the number of hosts and communication pattern, the resource allocation circuitry 120 may be configured to determine the required number of leaf switches and optical circuit connections to dynamically configure the network structure to execute the deep learning task. Furthermore, the resource allocation circuitry 120 may be configured to flexibly choose to either select specific hosts that will result in a specific network structure for a given communication pattern or simply decide a network structure that serves the communication pattern, implying the specific hosts to be used. This selection can be executed flexibly based on algorithms and what is deemed more beneficial for system utilization at any given instance. In specific embodiments, the resource allocation circuitry 120 may determine the required number of leaf switches based on at least the port capacity of each leaf switch and the total number of hosts. For instance, if each leaf switch supports 32 downlink ports, and there are 120 allocated hosts, then at least 4 leaf switches would be required. In specific embodiments, the resource allocation circuitry 120 may determine the required number of optical circuit connections between each pair of leaf switches to meet a network structure bandwidth requirement (e.g., full-bisection bandwidth). Upon determining the number of leaf switches and the optical circuit connections, the resource allocation circuitry 120 may dynamically configure the network structure. To this end, the resource allocation circuitry 120 may transmit configuration commands to the leaf and optical switches, initiating the establishment of the network according to the determined requirements. In embodiments where the network structure supports dynamic resource scaling, the resource allocation circuitry 120 may further adjust the allocation of computational and network resources based on real-time demands of the deep learning task. Post-configuration, the resource allocation circuitry 120 may trigger an execution of the deep learning task by transmitting the appropriate signal or command to the processor 112, which initiates the execution of the deep learning task. In specific embodiments, the resource allocation circuitry 120 may also continuously monitor network performance metrics and make real-time adjustments to maintain optimal performance.

In some embodiments, the system 102 may include hardware, software, firmware, and/or a combination of such components, configured to support various aspects of resource allocation implementations as described herein. It should be appreciated that in some embodiments, the resource allocation circuitry 120 may perform one or more of such example actions in combination with another circuitry of the system 102, such as the memory 114, processor 112, input/output circuitry 116, and communications circuitry 118. For example, in some embodiments, the resource allocation circuitry 120 utilizes processing circuitry, such as the processor 112 and/or the like, to form a self-contained subsystem to perform one or more of its corresponding operations. In a further example, and in some embodiments, some or all of the functionality of the resource allocation circuitry 120 may be performed by the processor 112. In this regard, some or all of the example processes and algorithms discussed herein can be performed by at least one processor 112 and/or the resource allocation circuitry 120. It should also be appreciated that, in some embodiments, the resource allocation circuitry 120 may include a separate processor, specially configured field programmable gate array (FPGA), or application specific interface circuit (ASIC) to perform its corresponding functions.

Additionally, or alternatively, in some embodiments, the resource allocation circuitry 120 may use the memory 114 to store collected information. For example, in some implementations, the resource allocation circuitry 120 may include hardware, software, firmware, and/or a combination thereof, that interacts with the memory 114 to send, retrieve, update, and/or store data.

Accordingly, non-transitory computer readable storage media can be configured to store firmware, one or more application programs, and/or other software, which include instructions and/or other computer-readable program code portions that can be executed to direct operation of the system 102 to implement various operations, including the examples described herein. As such, a series of computer-readable program code portions may be embodied in one or more computer-program products and can be used, with a device, system 102, database, and/or other programmable apparatus, to produce the machine-implemented processes discussed herein. It is also noted that all or some of the information discussed herein can be based on data that is received, generated and/or maintained by one or more components of the system 102. In some embodiments, one or more external systems (such as a remote cloud computing and/or data storage system) may also be leveraged to provide at least some of the functionality discussed herein.

### Example Topological Representation of the Network Structure

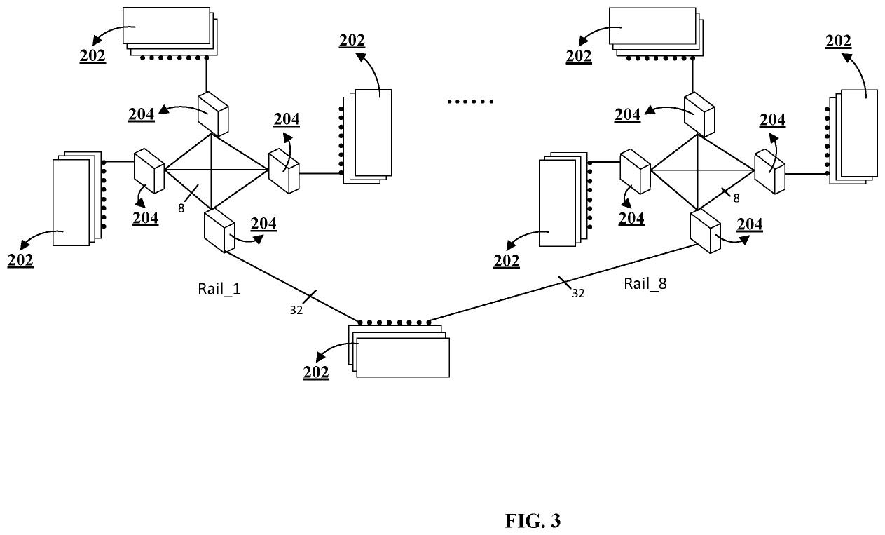

FIG. 3 illustrates a schematic representation of a complete graph structure comprising a plurality of hosts 202 and a plurality of leaf switches 204, in accordance with an embodiment of the invention. As shown in FIG. 3, the plurality of leaf switches 204 are interconnected using optical circuit connections to form a comprehensive graph structure. i.e., full graph. In this arrangement, each leaf switch 204, may be operatively interconnected to every other leaf switch 204 exemplifying the characteristics of a complete graph, wherein every node (or leaf switch, in this instance) maintains a direct connection to every other node.

As described herein, each host 202 may be configured to send a fraction (1/N) of its link's bandwidth to every other host in the network, where N is the number of allocated hosts. Furthermore, when a host 202 is positioned on a specific leaf switch 204, it may be configured to send a share of its bandwidth, calculated as (N-hp)/N, to hosts on all other leaf switches. Given these direct interconnections between the leaf switches 204, any host 202 attached to a particular leaf switch 204 may transmit and receive data from any other host 202 within the network structure 100, irrespective of the leaf switch 204 they are connected to. The direct pathways established by these optical circuit connections between the leaf switches 204 ensure a direct and efficient communication route.

### Example Methods for Allocation of Network Resources

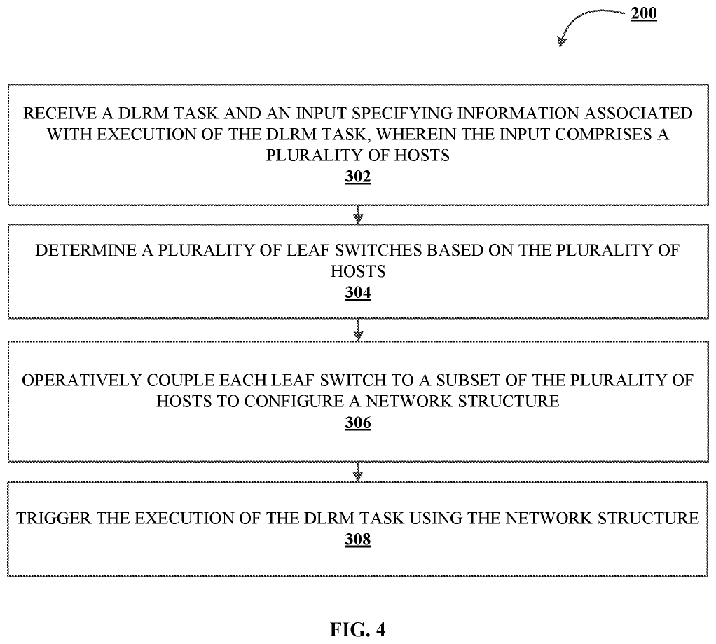

FIG. 4 illustrates an example method 300 for allocation of network resources for executing deep learning tasks, in accordance with an embodiment of the present disclosure. As shown in block 302, the method may include receiving a task and an input specifying information associated with execution of the task, wherein the input comprises a plurality of hosts. As described herein, the task may be a deep learning task, such as a DLRM task. The efficacy of executing a DLRM task (e.g., DLRM training) may be closely linked to the efficient allocation and utilization of network resources. In addition to the allocation of computational resources, ensuring optimality necessitates efficient distribution of tasks across multiple hosts. Part of this distribution requires the knowledge of the specific communication pattern to be employed. As such, in some embodiments, the input may also include a communication pattern (e.g., all-to-all, reduction operations, and/or other communication patterns).

As shown in block 304, the method may include determining a plurality of leaf switches based on the plurality of hosts. As described herein, each leaf switch may include a plurality of uplink ports. These uplink ports may be configured to operatively couple the leaf switch to a plurality of optical switches. Additionally, each leaf switch may include a plurality of downlink ports. These downlink ports may be configured to operatively couple the leaf switch to the plurality of hosts. For instance, if the number of allocated hosts, N, is 128, and each leaf switch has 32 ports for uplink (connecting to an optical switch) and 32 ports for downlink (connecting to a host), then each leaf switch is capable of being operatively coupled to 32 hosts. Therefore, for 128 hosts, a minimum of 4 leaf switches may be required. Each leaf switch may be operatively coupled to a varying number of hosts (h1, h2, . . . , hp), where h1 refers to the number of hosts under leaf 1, h2 refers to number of hosts under leaf 2, and so on, where p=4 and 20 hi=128.

As shown in block 306, the method may include operatively coupling each leaf switch to a subset of the plurality of hosts to configure a network structure. In this way, embodiments of the invention may dynamically configure the network structure, adapting in real-time to the given parameters and information to optimize data flow and connectivity. Having operatively coupled each leaf switch to the subset of the plurality of hosts, the method may then include determining, based on the communication pattern, a number of optical circuit connections required to operatively interconnect each pair of leaf switches from the plurality of leaf switches. Each optical circuit connection may be a bidirectional communication link via which data can be transmitted and received over the same connection, facilitating two-way communication without the need for separate transmission and reception paths.

In some embodiments, the dynamically-formed network structure may be associated with specific bandwidth requirements, such as a full-bisection bandwidth. The full-bisection bandwidth requirement ensures that the aggregate bandwidth between any two halves of a network structure is maximized. In other words, if the network structure is bisected into two equal parts, the communication capacity between these two parts is optimized, allowing for the unhindered flow of data. Such a requirement is especially vital in tasks that require intensive data exchange between different parts of the network. As a result, the method may include determining the number of optical circuit connections to interconnect each pair of leaf switches to ensure compliance with the specific bandwidth requirement for optimal data transfer rates, minimal potential bottlenecks, and consistent performance across the network. However, even if the number of optical circuit connections are unable to meet the specific bandwidth requirement, such connections can still be utilized, albeit with reduced performance.

In some embodiments, for any given pair of leaf switches, the pair may include a first leaf switch and a second leaf switch. The number of optical circuit connections for each pair of leaf switches may be determined based on at least the subset of the plurality of hosts operatively coupled to the first leaf switch (hi), the subset of the plurality of hosts operatively coupled to the second leaf switch (hj), and the plurality of allocated hosts (N). The bandwidth requirement for the determining the number of optical circuit connections may be defined by a bandwidth parameter, q, which acts as a scaling factor to align the number of connections with the actual bandwidth demands. For instance, to achieve full bisection bandwidth, q may be set to 1. On the other hand, for requirements less stringent than full bisection bandwidth, q may be set to a value less than 1, reflecting a proportional decrease in optical circuit connections. Accordingly, the number of optical circuit connections for each pair of leaf switches may be determined based on the following equation:

$$q * ⌈ \frac{{h}_{i} * {h}_{j}}{N} ⌉$$

In some embodiments, an integer approximation function (e.g., ceiling function, rounding function, and/or the like) may be used to round the number of optical circuit connections up to a whole number. As in the previous example, if there is an equal number of hosts under each leaf switch, the required number of optical switch uplinks between each leaf switch may be determined as [(32*32)/128]=8. Therefore, the total number of optical switch uplinks required for each leaf switch is 8+8+8=24 in this example. Basing the number of optical circuit connections on these specific parameters ensures a balanced and effective distribution of bandwidth and resources across the network. In example embodiments where 8 optical circuit connections may be required to meet the specific bandwidth requirements, there may be a scenario where only 7 optical circuit connections may be available in the network structure. In such cases, the network can still operate with these available connections, albeit with potential reductions in data transfer rates and overall performance. Adjustments might be made to the communication patterns or workload distributions to optimize performance given the reduced bandwidth availability. This approach offers flexibility, allowing the network to function even when optimal conditions are not met.

Once determined, the method may include operatively interconnecting, using the optical circuit connections, the plurality of leaf switches. In some embodiments, when operatively interconnected, the plurality of leaf switches may form a complete graph, such that each leaf switch may be directly connected to every other leaf switch. Consequently, each host may be configured to transmit and receive data from every other host via the leaf switches, and the optical circuit connections interconnecting the leaf switches. The advantage of a complete graph structure is the direct and efficient communication pathway it provides between any two hosts.

As shown in block 308, the method may include triggering the execution of the task using the network structure. In embodiments where the task is a DLRM task, triggering the execution of the DLRM task may involve initiating specific DLRM operations, such as DLRM training, using the pre-configured network structure. As the DLRM task progresses, the network structure, tailored to the DLRM task specifics, ensures that data flow and communication processes align with the requirements of the DLRM task. Thus, by leveraging the network structure, the method ensures a harmonized execution environment for the DLRM task.

FIG. 4 thus illustrates flowcharts describing the operation of apparatuses, methods, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 114 of the system 102 and executed by a processor 112 of the system 102. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases the method may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### INCORPORATION BY REFERENCE

To supplement the present disclosure, this application further incorporates entirely by reference the following commonly assigned patent applications:

| | U.S. patent | | |
|---|---|---|---|
| | application | | |
| Docket Number | Ser. No. | Title | Filed On |
| 048833.000172 | To be | SYSTEM FOR ALLOCATION OF | Concurrently |
| | assigned | NETWORK RESOURCES FOR | herewith |
| | | EXECUTING LARGE LANGUAGE | |
| | | MODEL (LLM) TASKS | |

1. A method for allocation of network resources for executing a deep learning task, the method comprising:
receiving a task and an input specifying information associated with execution of the task, wherein the input comprises a plurality of hosts and a communication pattern;
determining a network structure and a corresponding subset of the plurality of hosts that serve the communication pattern;
determining a plurality of leaf switches based on the subset of the plurality of hosts;
operatively coupling the plurality of leaf switches to the subset of the plurality of hosts to configure the network structure; and
triggering the execution of the task using the network structure.

2. The method of claim 1, wherein the method further comprises:
determining, based on the communication pattern, a number of optical circuit connections required to operatively interconnect each pair of leaf switches from the plurality of leaf switches; and
operatively interconnecting, using the optical circuit connections, the plurality of leaf switches.

3. The method of claim 2, wherein operatively interconnecting, using the optical circuit connections, the plurality of leaf switches forms a complete graph.

4. The method of claim 2, wherein the optical circuit connections are bidirectional links.

5. The method of claim 1, wherein the communication pattern comprises at least one of an all-to-all, a reduction operation, or scatter-gather.

6. The method of claim 2, wherein the number of optical circuit connections determined to satisfy a bandwidth requirement associated with the network structure.

7. The method of claim 6, wherein each pair of leaf switches comprises a first leaf switch and a second leaf switch, wherein the number of optical circuit connections for each pair of leaf switches is determined based on at least the subset of the plurality of hosts operatively coupled to the first leaf switch (hi), the subset of the plurality of hosts operatively coupled to the second leaf switch (hj), and the plurality of hosts (N).

8. The method of claim 7, wherein the number of optical circuit connections is determined using an integer approximation function to round the number of optical circuit connections up to a whole number, wherein the integer approximation function comprises at least a ceiling function or a rounding function.

9. The method of claim 8, wherein the number of optical circuit connections for each pair of leaf switches is determined based on:
$$q * ⌈ \frac{{h}_{i} * {h}_{j}}{N} ⌉$$

10. The method of claim 9, wherein if the bandwidth requirement is a full bisection bandwidth requirement, q is set to 1, and wherein if the bandwidth requirement is less than the full bisection bandwidth requirement, q is set to a value less than 1.

11. The method of claim 1, wherein each leaf switch comprises a plurality of uplink ports configured to operatively couple said leaf switch to a plurality of optical switches and a plurality of downlink ports configured to operatively couple said leaf switch to the plurality of hosts.

12. The method of claim 1, wherein the task is a deep learning recommendation model (DLRM) task.

13. A system for allocation of network resources for executing a deep learning task, the system comprising:
a processing device; and
a non-transitory storage device containing instructions that, when executed by the processing device, cause the processing device to:
receive a task and an input specifying information associated with execution of the task, wherein the input comprises a plurality of hosts and a communication pattern;
determine a network structure and a corresponding subset of the plurality of hosts that serve the communication pattern;
determine a plurality of leaf switches based on the subset of the plurality of hosts;
operatively couple the plurality of leaf switches to the subset of the plurality of hosts to configure the network structure; and
trigger the execution of the task using the network structure.

14. The system of claim 13, wherein the instructions, when executed by the processing device, further cause the processing device to:
determine, based on the communication pattern, a number of optical circuit connections required to operatively interconnect each pair of leaf switches from the plurality of leaf switches; and
operatively interconnect, using the optical circuit connections, the plurality of leaf switches.

15. The system of claim 14, wherein operatively interconnecting, using the optical circuit connections, the plurality of leaf switches forms a complete graph.

16. The system of claim 14, wherein the optical circuit connections are bidirectional links.

17. The system of claim 13, wherein the communication pattern comprises at least one of an all-to-all, a reduction operation, or scatter-gather.

18. The system of claim 14, wherein the number of optical circuit connections determined to operatively interconnect each pair of leaf switches satisfies a full-bisection bandwidth requirement associated with the network structure.

19. The system of claim 18, wherein each pair of leaf switches comprises a first leaf switch and a second leaf switch, wherein the number of optical circuit connections for each pair of leaf switches is determined based on at least the subset of the plurality of hosts operatively coupled to the first leaf switch (hi), the subset of the plurality of hosts operatively coupled to the second leaf switch (hj), and the plurality of hosts (N).

20. The system of claim 19, wherein the number of optical circuit connections is determined using an integer approximation function to round the number of optical circuit connections up to a whole number, wherein the integer approximation function comprises at least a ceiling function or a rounding function.

21. The system of claim 20, wherein the number of optical circuit connections for each pair of leaf switches is determined based on:
$$q * ⌈ \frac{{h}_{i} * {h}_{j}}{N} ⌉$$

22. The system of claim 21, wherein if the bandwidth requirement is a full bisection bandwidth requirement, q is set to 1, and wherein if the bandwidth requirement is less than the full bisection bandwidth requirement, q is set to a value less than 1.

23. The system of claim 13, wherein the task is a deep learning recommendation model (DLRM) task.

24. A computer program product for allocation of network resources for executing a deep learning task, the computer program product comprising a non-transitory computer-readable medium comprising code that, when executed, is configured to cause a processing device to:
receive a task and an input specifying information associated with execution of the task, wherein the input comprises a plurality of hosts and a communication pattern;
determine a network structure and a corresponding subset of the plurality of hosts that serve the communication pattern;
determine a plurality of leaf switches based on the subset of the plurality of hosts;
operatively couple the plurality of leaf switches to the subset of the plurality of hosts to configure the network structure; and
trigger the execution of the task using the network structure.

25. The computer program product of claim 24, wherein the input comprises a communication pattern, and wherein the code, when executed, is further configured to cause the processing device to:
determine, based on the communication pattern, a number of optical circuit connections required to operatively interconnect each pair of leaf switches from the plurality of leaf switches; and
operatively interconnect, using the optical circuit connections, the plurality of leaf switches.
